(19) United States
(12) Patent Application Publication
(10) Pub. No.: US 2019/0323253 A1
(43) Pub. Date: Oct. 24, 2019

(54) SECURE PLANT CULTIVATION CHAMBER AND FACILITY

(71) Applicant: WHITE PODS PHARM CANADA INC., Ottawa (CA)

(72) Inventor: ROBERT BENVIE, OTTAWA (CA)

(21) Appl. No.: 16/388,103

(22) Filed: Apr. 18, 2019

Related U.S. Application Data
(60) Provisional application No. 62/659,341, filed on Apr. 18, 2018.

(51) Int. Cl. E04H 5/08; A01G 22/15; A01G 9/24; A01G 9/14; A01D 45/00; G06Q 10/08; G05B 19/4155

(52) U.S. Cl. CPC E04H 5/08; A01G 22/15; A01G 9/246; A01G 9/247; A01G 9/18; A01D 45/00; G06Q 10/0832; G06Q 10/087; G05B 19/4155; A01G 9/143

(57) ABSTRACT

A secure plant cultivation facility in which each growth cultivation chamber and drying chamber contained therein are assigned with a unique address or identifier so as to facilitate the production, packaging, storage and tracking of each batch or lot of controlled substance associated to a given client or person and/or strain of controlled substance.

### CROSS REFERENCE TO RELATED APPLICATION

This application claims benefit, under 35 U.S.C. § 119(e), of U.S. provisional application Ser. No. 62/659,341, filed on Apr. 18, 2018, which is incorporated herein in its entirety by reference.

### BACKGROUND OF THE INVENTION

Because of the highly-anticipated boom in the medical marijuana industry as well as proposed legislative changes in Canada (i.e., Bill C-45 entitled, An Act respecting cannabis and to amend the Controlled Drugs and Substances Act, the Criminal Code and other Acts) and the corresponding regulation thereof, growers are searching for large spaces to grow crops (i.e., cannabis). In conventional crop production, crops are grown either outside, indoors or in a greenhouse setting, in which certain factors are monitored; for example: lighting, plant nutrients, pH levels, humidity, air movement and pest control (see: Danko, D., Cannabis cultivation basics, Hightimes, Dec. 26, 2013, available at: http://hightimes.com/author/danko). Not only must attention be given to the foregoing factors, but consideration must also be given to: (i) access to uninterrupted high-wattage electricity, (ii) sophisticated security systems, (iii) a location close to major distribution centers, as well as (iv) contamination and/or crop control, especially when licensed producers in the field of cannabis are not permitted to make use of additives, organic solvents or other pest control products, as set forth in current legislation, including for example the Pest Management Regulatory Agency's enabling legislation and corresponding regulations.

Though indoor and greenhouse grow settings, as it appears in FIG. 1 (“Prior Art”) and http://ggs-greenhouse.com/marijuana/marijuana-indoor-grows, allow for a degree of contamination control, they do not allow for the complete elimination of cross-contamination from neighboring crops or other plant varieties, which can alter the plant's profile, medicinal effect, as well as the possible of unwilling creation of new hybrid plants (Rieseberg, L. H., Hybrid origins of plant species, Annu. Rev. Ecol. Syst. 1997, 28:359-89). It is also known that outdoor plants tend to be less fully developed and that wind and rain can lead to plant destruction. It is also known that wind degrades Δ9-tetrahydrocannabinol (“THC”) and terpenes, bruising trichomes and breaking branches. On the other hand, rain, especially during the later plant flowering stage, can create molds and bud rot. Plants grown in indoor environments further require regular supervision for pest control.

Recently, modular environments, as it appears in FIGS. 2 to 8 of the present application have been made available to the public; wherein, shipping containers, which are usually 8 ft×20 ft or 8 ft×40 ft, have been converted into cultivation rooms which allows users to control air temperature, water temperature, humidity levels, CO₂ levels, and ventilation methods.

Also disclosed are interchangeable modular systems for cannabis cultivation and production, which can make use of a panelized ceiling systems as disclosed in U.S. Pat. No. 7,937,903 B2 (McGee et al.).

By way of example, U.S. publication no. 20140115958 A1 to GreenTech Agro LLC discloses a system comprising an enclosed space defining a controllable environment chamber, at least one monitoring device configured to measure multiple characteristics of an environment (i.e., wind velocity) within the chamber, a control system configured to: (i) receive from a user a selection of a climate of a specified region of the world, (ii) determine a sequence of environments over time that comprise the selected climate, and (iii) based on the determined sequence, control operation of the actuators to replicate the sequence of environments within the chamber such that a climate within the chamber replicates the selected climate, amongst other components.

International laid-open publication no. WO2016/061672 A1 to Avid Growing Systems Inc. discloses systems, apparatuses and methods for growing marijuana plants. More particularly, this publication discloses an apparatus for growing marijuana plants comprising: a growth chamber containing a climate controlled micro-climate under negative air pressure; at least one marijuana plant support structure situated in the growth chamber; the plant support structure configured to support a marijuana plant whereby roots of the marijuana plant are exposed to air in the growth chamber; a water management system in fluid communication with the plant support structure configured to deliver water and other chemical components to at least the roots of the marijuana plant; at least one sensor configured to sense at least one parameter of the growth chamber, water management system or marijuana plant; and a controller in electronic communication with the at least one sensor and one or more of the growth chamber and water management system; the controller configured to control the growth chamber, water management system or both in response to a signal from the at least one sensor.

According to the foregoing application, the air blower tubes comprise a plurality of blowholes through which air is vigorously blown to encourage air mixing and circulation within the growth chamber. The growth chamber further comprises an air outlet through which the circulating air stream exits the growth chamber. This architecture allows for the maintenance of a negative pressure within the growth chamber, relative to an external environment outside of the growth chamber. Also disclosed in this application is the incorporation of flavor additives during one or more plant growth phases so as to provide a unique way of producing flavored marijuana. As it can be seen in the figures of this International laid-open publication no. WO20161061672 A1, the growth chambers contain a plurality of growing tubes in which plants are supported with root balls.

A drawback of the grow environments of the prior art is that they are setup in such a manner to pack as many plants as possible (i.e., as densely as possible) so as to obtain the highest plant yield per square foot (Caulkins, J., Cohen, M., Zamarra, L., Estimating adequate licensed square footage for production, BOTEC Analysis Corporation), which may increase the risk of, for example: (1) pests and disease, (2), fungal contamination (i.e., airborne fungal spores, Martyny J W et als., Potential exposures associated with indoor marijuana growing operations, J. Occup Environ Hyg., 2013; 10(11): 622-39 and Kowalski, W., Aerobiological Engineering Report 16414), (3) cross-contamination, hybridization and/or pollination between plant varieties should they come into contact with another, hermaphrodites or that male plants had not all be discarded, and (4) other miscellaneous causes. If not addressed, the foregoing drawbacks may affect the ratio of cannabidiol (CBD) to THC in the plant, which may itself may alter the desired pharmacological effects of cannabis as choice of therapeutic agent for a given medical indication (Fasinu P., et als. Current status and prospects for cannabidiol preparations as new therapeutic agents, Pharmacotherapy, vol. 36, no. 7 (2016)).

A further drawback of the grow environments of prior art is that the grow environment may not be properly regulated. For example, air maybe re-circulated; thereby not allowing to efficiently control temperature and CO₂ levels, which is known to drop as plants consume CO₂ during photosynthesis, which may also affect yield. Other potential drawbacks include those related to determining suitable and efficient environmental conditions for indoor mass cultivation of plants for pharmaceutical use, as referred to in Chandra S. et als., Photosynthetic response of Cannabis sativa L. to variations in photosynthetic photon flux densities, temperature and CO₂ conditions, Physiol Mol Biol Plants, 2008 October; 14(4): 299-306 and Chandra et als., Photosynthetic response of Cannabis sativa L., an important medicinal plant, to elevated levels of CO₂, Physiol Mol Biol Plants. 2011 July; 17(3): 291-295.

Yet another drawback of certain grow environments of the prior art is that medical cannabis growers may restrain themselves to a certain plant type, which may not satisfy patient demand for a given condition. Indeed, if a patient does not have access to a certain type medical cannabis, the patient and/or his physician may need to reconfigure the patient's dosing regimen, based on other plant types, which may not provide the desired outcome or desired therapeutic effect (or response). Indeed, the reconfiguration (or design) of a patient's dosing regimen, for a given condition (i.e., pain) is a long and difficult process, which may require the evaluation of pharmacokinetics and pharmacodynamics, as well as other clinical factors, such as the clinical state of the patient, age, weight, condition to be treated, as well as other factors. In cases where, a particular strain of cannabis is over-produced, excess production may find itself going into the underground economy.

There is therefore a need an invention that overcomes the drawbacks of the prior art by providing a secure plant cultivation facility in which a safe and responsible supply chain of cannabis is established.

### SUMMARY OF THE INVENTION

In one aspect, there is provided a secure plant cultivation facility in which each growth cultivation chamber and drying chamber contained therein are assigned with a unique address or identifier so as to facilitate the production, packaging, storage and tracking of each batch or lot of controlled substance associated to a given client or person and/or strain of controlled substance.

Preferably, the facility comprises of several chambers, such as: at least one climate controlled growth cultivation chamber with a unique address or identifier for growing a controlled substance; at least one drying chamber with a corresponding unique address or identifier with the at least one climate controlled growth chamber; said drying chamber used for subjecting the controlled substance to a drying process; at least one laboratory for testing said controlled substances and ensuring quality thereof; a storage chamber, which allows for the storage of controlled substances for clients or persons who require the controlled substance up to the shipment thereof; said storage chamber further comprising a vault; security measures which allow for the detection and monitoring of the facility as well as the safeguarding the controlled substances contained therein from unauthorized access; a computer and/or information technology system for registering, recording, identifying and verifying clients and persons who have ordered the controlled substance so as to ensure delivery of a given controlled substance thereto; and other multi-purpose rooms.

The facility according to the present invention may further provided with: security measures that allow for the monitoring of said facility, including each of its components, as well as the tracking of cannabis; a computer and/or information technology (“IT”) system that allow for the monitoring of said facility, including each of its components as well as the tracking of cannabis; a cannabis tracking system; growth cultivation and drying chambers which may be assigned with a unique address or identifier so as to facilitate the production, packaging, storage and tracking of each batch or lot of controlled substance associated to a given client or person and/or particular strain of controlled substance, amongst other features, which shall be disclosed herein or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE FIGURES

Other objects and advantages of the invention will become apparent to those skilled in the relevant art(s) upon reading the following detailed description of preferred embodiments, in conjunction with the accompanying drawings, in which like reference numerals have been used to designate like elements, and in which:

FIGS. 1 to 8 illustrate different grow rooms of the prior art;

FIGS. 9 and 10 illustrates an exemplary floor plan of the novel facility for cultivating plants;

FIG. 11 is an illustration of a growth cultivation chamber according to the present invention; and

FIG. 12 is an illustration of a drying chamber according to the present invention.

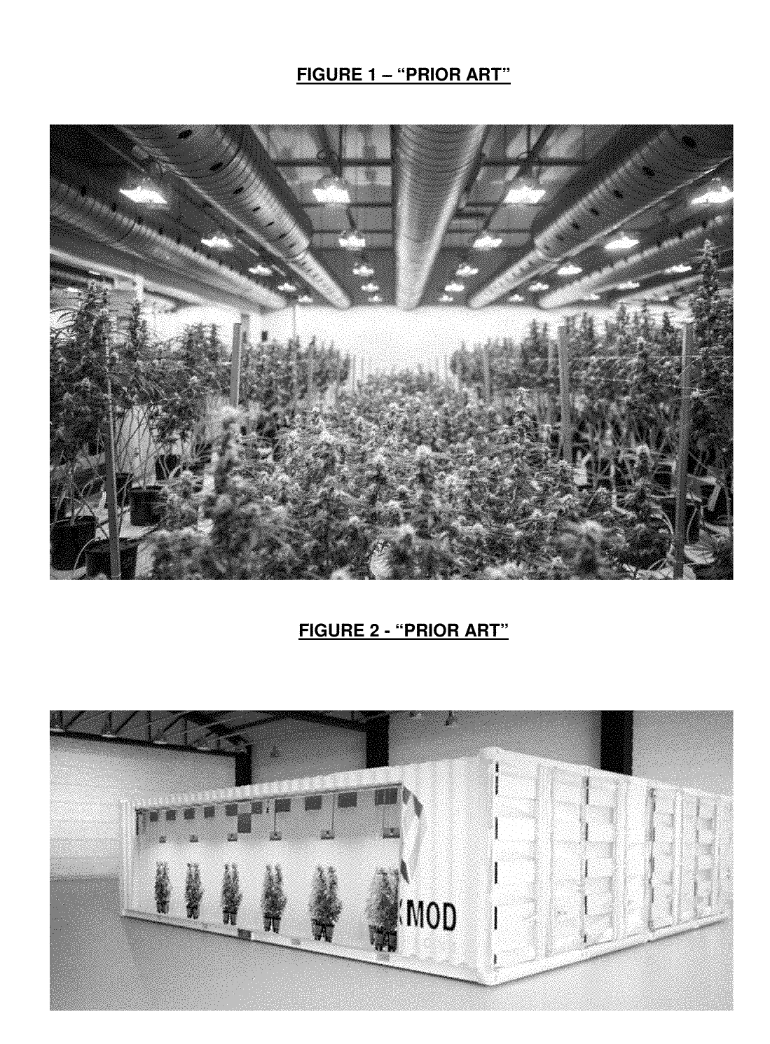

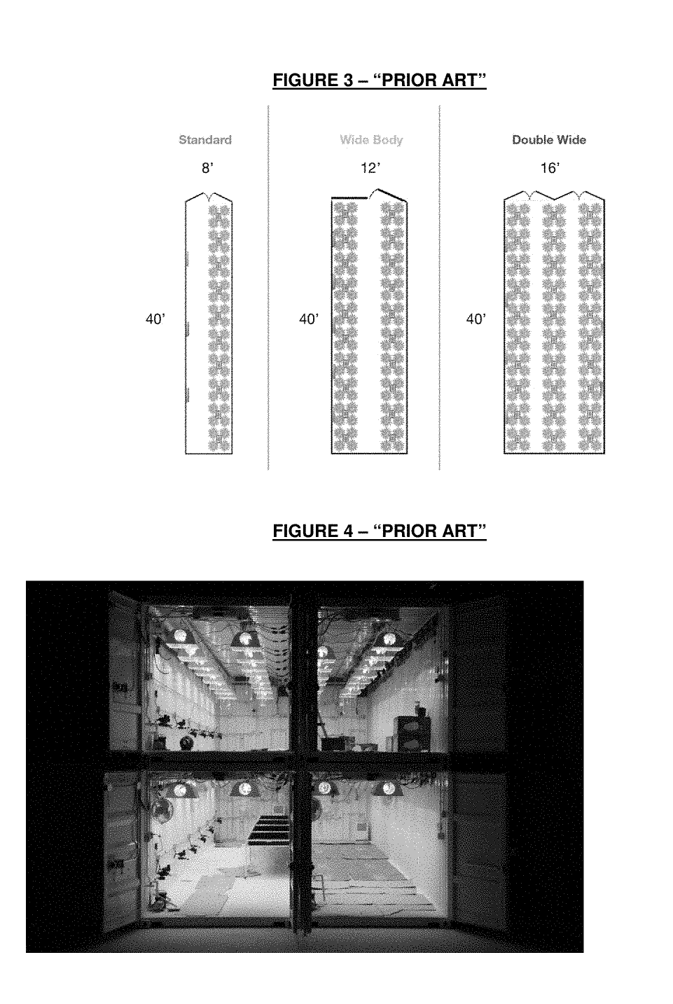

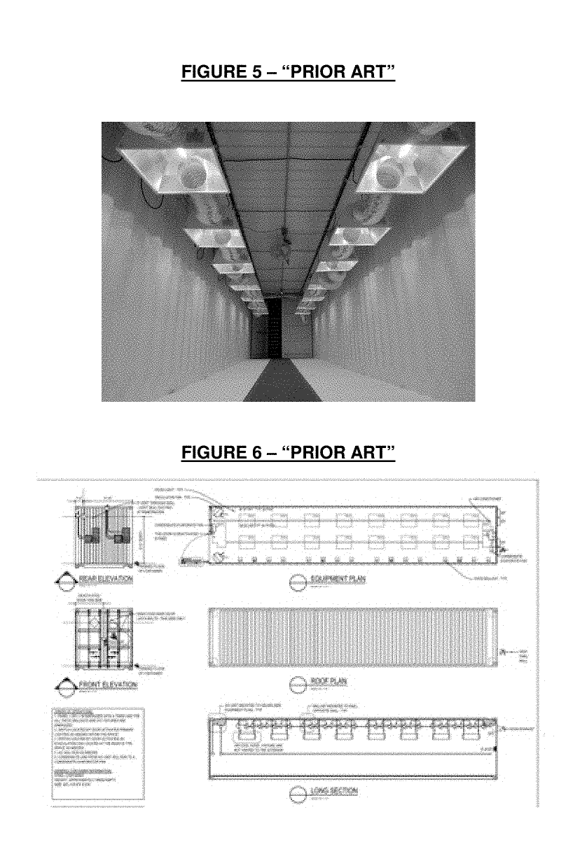

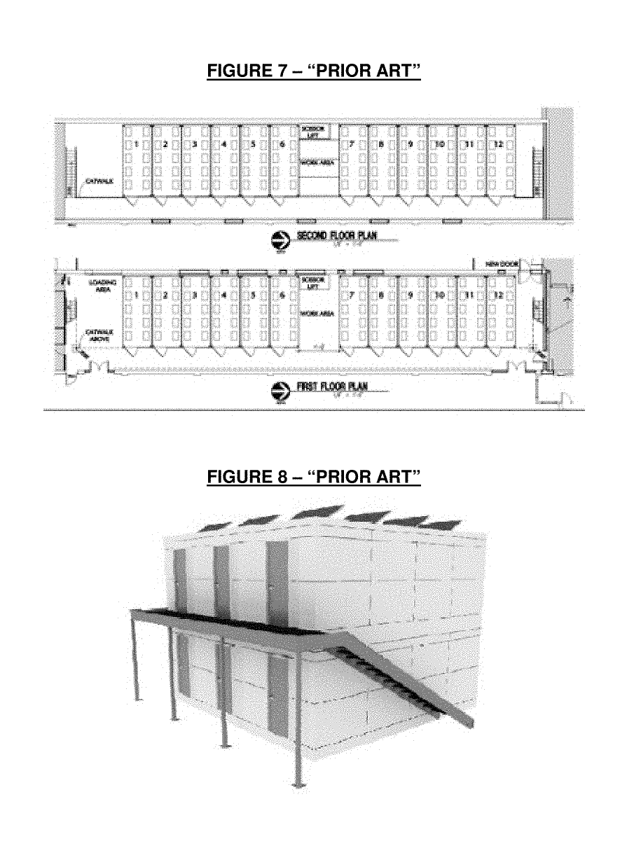

### DETAILED DESCRIPTION

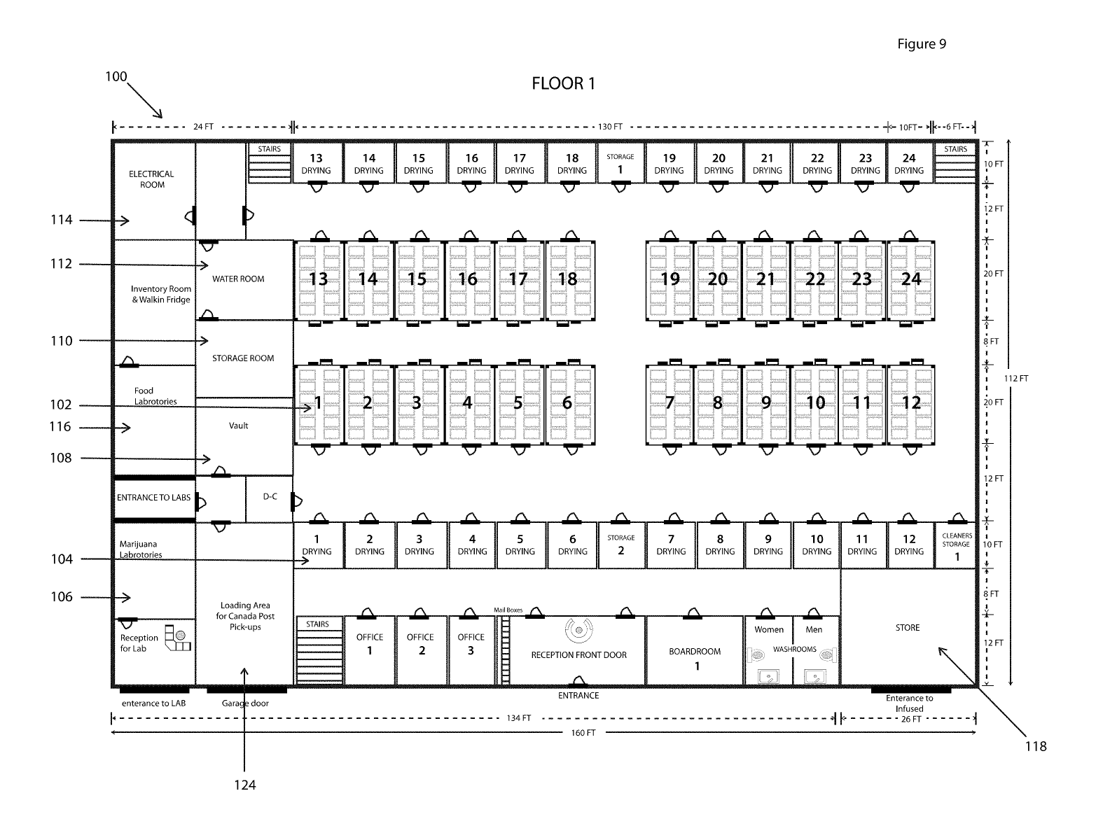

A detailed description of the inventions are presented below. The explanation will be by way of exemplary embodiments to which the present invention(s) are not limited. As it can be seen from FIGS. 9 to 12 of the present application, there is provided a secure plant cultivation facility 100 in which each growth cultivation chamber 102 and drying chamber 104 contained therein are assigned with a unique address or identifier so as to facilitate the production, packaging, storage and tracking of each batch or lot of controlled substance associated to a given client or person. In a preferred embodiment the facility 100 generally comprises of: (i) at least one climate controlled growth cultivation chamber 102, which is attributed with a unique address or identifier for growing a controlled substance; (ii) at least one drying chamber 104, which is attributed with a corresponding unique address or identifier with the at least one climate controlled growth chamber; said drying chamber used for subjecting the controlled substance to a drying process; (iii) at least one laboratory 106 for testing said controlled substances and ensuring quality thereof; (iv) a storage chamber 110, which allows for the storage of controlled substances for clients or persons who require the controlled substance up to the shipment thereof; said storage chamber further comprising a vault 108; (v) security measures which allow for the detection and monitoring of the facility as well as the safeguarding the controlled substances contained therein from unauthorized access; (vi) a computer system for registering, recording, identifying and verifying clients and persons who have ordered the controlled substance so as to ensure delivery of a given controlled substance thereto; and (vii) other multi-purpose rooms, such as water rooms 112, electrical rooms 114, food laboratories to infuse foods 116, store 118, cloning room 120, extracting laboratory 122, loading docks 124, and DC chambers 126, as well as other types of rooms which are identified on FIGS. 9 to 12 of the present application.

The Secure Plant Cultivation Facility

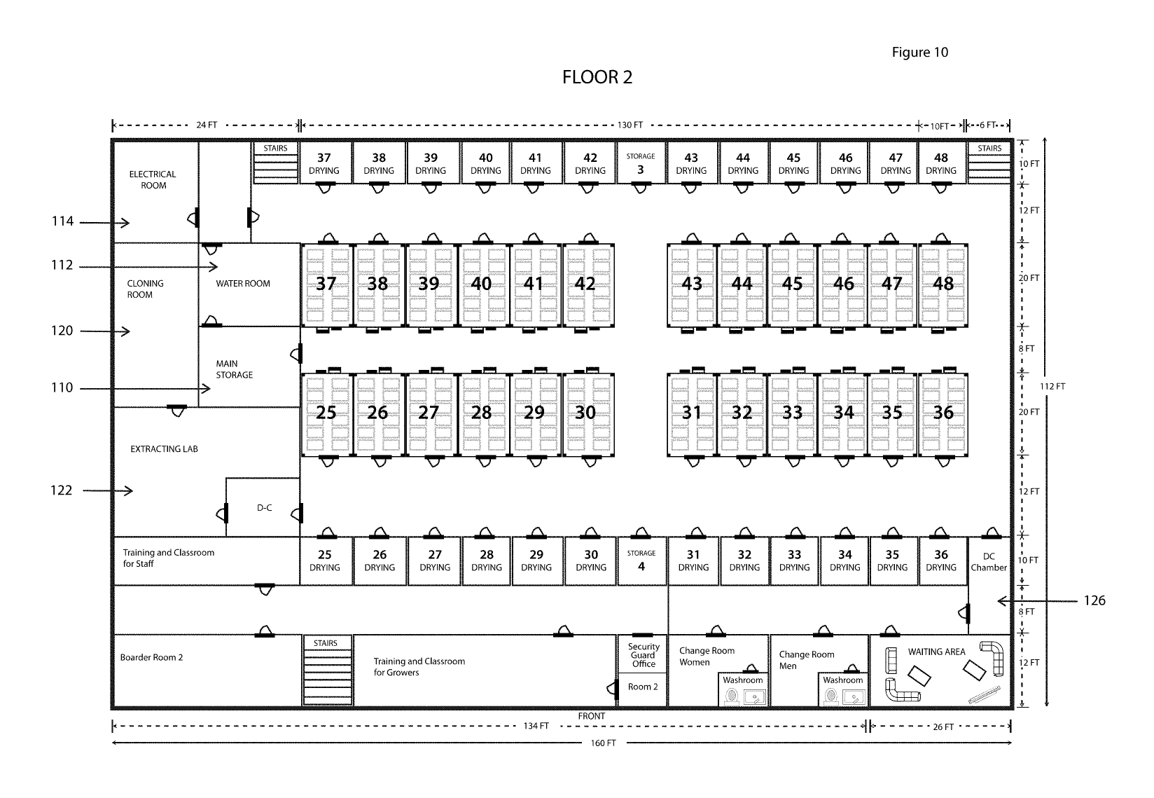

By way of example, and as it can be seen in FIGS. 9 and 10, the secure plant cultivation comprises of several chambers and rooms to facilitate the production, packaging, storage, tracking and transport of each batch or lot of controlled substance associated to a given client or person. In a preferred embodiment, the plant facility may comprise of one or more floors; for example, a ground floor, i.e. a first floor (FIG. 9), easily accessible to ground transport, and a mezzanine floor, i.e., a second floor (FIG. 10). In the case that the at least one climate controlled growth cultivation chamber 102 or at least one drying chamber 104 need to be transported to either floor, the plant cultivation facility 100 is also provided with the necessary lifts and devices to ensure tracking and movement of growth chambers. Indeed, one of keys of the invention according to the present invention is the growth cultivation chamber 102 and at least one drying chamber 104 is that they are assigned with the same (or corresponding) unique address or identifier so as to allow licensed producers to produce, package, store, track each batch or lot of controlled substance to be grown and finally delivered to a given client or person. As it can be seen in FIGS. 9 and 10, each growth cultivation chamber 102 is attributed a unique address or identifier, i.e., 1, 2, 3, 4, 5 and etc. which corresponds (or mated) to drying chamber 104, which is attributed the same unique address or identifier, i.e., 1, 2, 3, 4, 5 and etc. so as to avoid any potential mix-ups in the production and tracking of unique batches or lots of controlled substances being grown and dried during the production and processing phases; especially considering that each controlled substance may be contain a different strain of cannabis or different ratios of cannabidiol (also known as CBD) to (−)-trans-Δ⁹-tetrahydrocannabinol (also known as THC) are being sought.

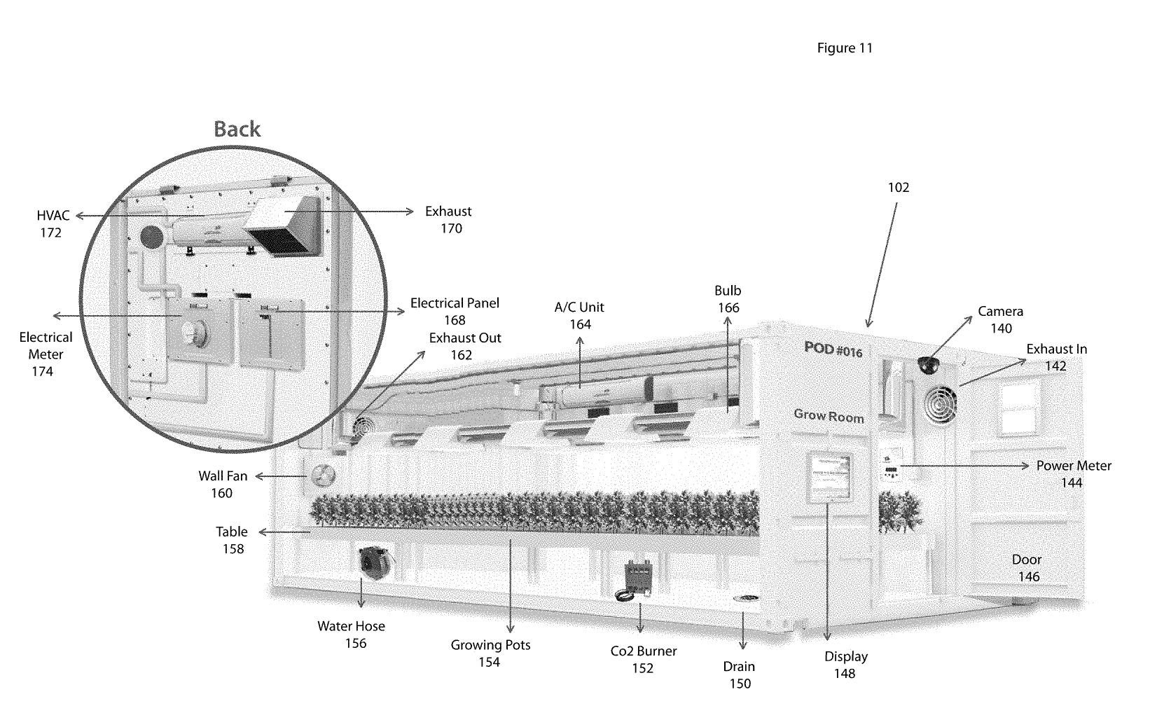

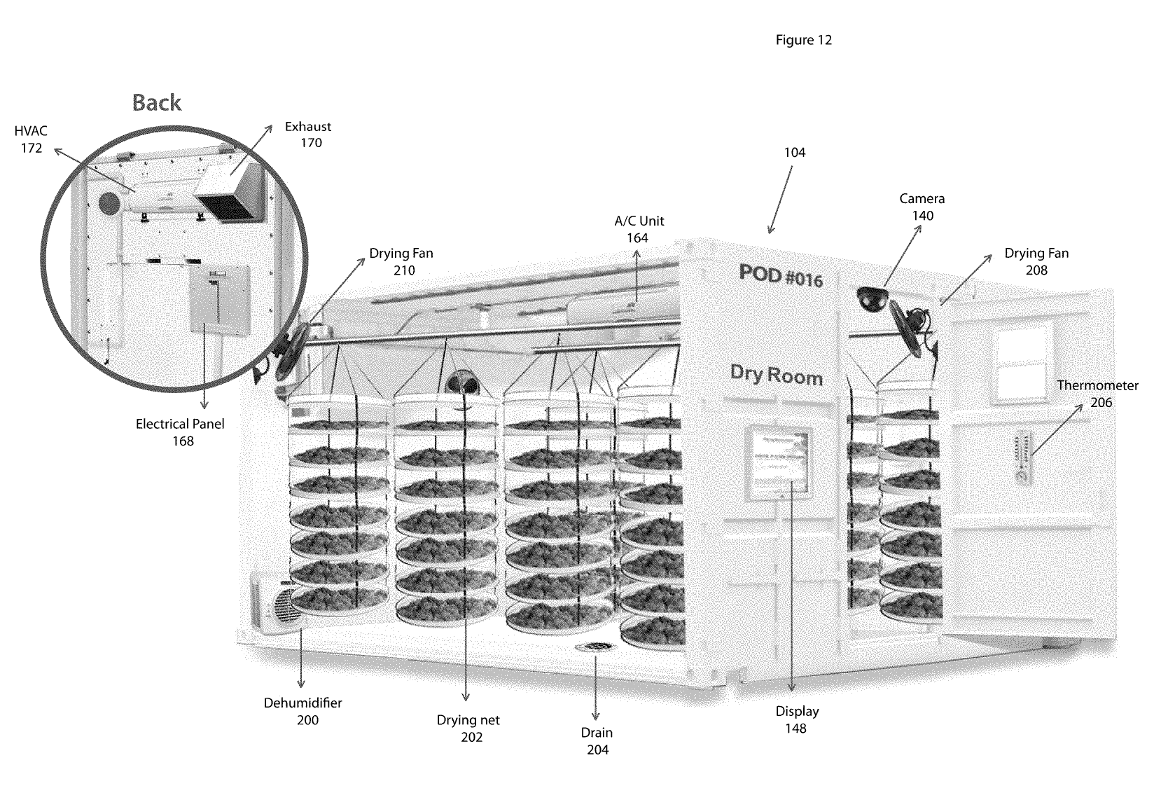

At Least One Growth Cultivation Chamber and at Least One Drying Chamber (FIGS. 11 and 12)

The components of the growth cultivation chamber 102 and a drying chamber 104 shall be discussed in further detail hereinbelow.

At Least One Laboratory

As it can be seen in FIGS. 9 and 10, the plant cultivation facility 100 is further provided with a laboratory 106 in which the plant and/or end-product can be tested, for its potency, THC and CBD levels, metals, mold and other chemical agents, such as pesticides, which should not be present. The laboratory shall also contain all other such equipment, such as extraction equipment, distillation equipment, purging ovens, rosin press and other such equipment that may be required in the analysis, production and transformation of cannabis. The plant cultivation facility is also provided with food laboratories (infuse foods) 116.

Inventory Room and Refrigeration

As it can be seen in FIG. 9, the plant cultivation facility can also be provided with an inventory room and refrigeration center. In this room raw materials and/or end product can be inventoried, catalogued and refrigerated if need be.

At Least One Vault Room

According the present invention, the plant cultivation facility 100 is provided with a vault 108. In a preferred embodiment, the vault room allows for storage of excess marijuana. By way of example, a patient with an allotment of 3 grams per day is allowed to have 675 grams of indoor cannabis or 2250 grams of outdoor cannabis stored at home. Alternatively, a patient with an allotment of 5 grams per day is allowed to have 1125 grams of indoor or 3750 grams of outdoor cannabis at home, Indeed, if the patient does not have a safe place to store is allotment of marijuana for medical purposes, the patient can make use of the Applicant's vault for safekeeping of the patients excess medical marijuana, and which is further provided environmental controls.

At Least One Storage Room

As it can be seen in FIGS. 9 and 10, the plant cultivation facility is also provided with a storage room 110.

At Least One Water Room (or Reservoir)

As it can be seen in FIGS. 9 and 10, the plant cultivation facility is also provided with a water room 112. In a preferred embodiment, the water room is temperature controlled and contains one or more water reservoirs. For example, the water room may control a first reservoir of 10,000 liters and a second reservoir of 5,000 liters.

Electrical Room

As it can be seen in FIGS. 9 and 10, the plant cultivation facility 100 is provided with one or more electrical rooms 114 so as to supply electricity to each of the components contained therein, including but not limited to the at least one growth cultivation chamber 102 and the at least one drying chamber 104.

In a preferred embodiment, the plant cultivation facility 100 is further comprised of a CSA (formerly known as the Canadian Standards Association, now CSA group) power generating set. Preferably, the power generating set is comprised of a control panel, a mainline circuit breaker, an automatic transfer switch (ATS) and other components, which renders it reliable and of sound economical operation. Indeed, one of the benefits of making use of an ATS is that it allows for a smooth load transfer from utility to an emergency source and back again. Preferably, the power generating system is an uninterrupted power source (UPS).

Store

As it can be seen in FIG. 9, the plant cultivation facility can also be provided with a store 118.

Cloning Room

As it can be seen in FIG. 10, the plant cultivation facility 100 further comprises a cloning (or clone) room 120, as known to a person skilled in the art. An advantage of having such a clone room 120 in the plant cultivation facility 100 of the present invention is that it allows for the producers to maintain a genetic library of the controlled substances, such as marijuana. As for any other facility, the clone room 120 should be clean and sterile prior to use, and be provided with: (i) proper air filters and clean airflow so as to prevent airborne pathogens such as mould and fungus spores from infesting young cuttings; (ii) lighting, such as blue-white lights (“cool lights”) to stimulate vegetative growth; (iii) proper trays and lids that must be verified several times during the day so as to avoid issues of excessive humidity and be able to assess the general rate of rooting. It is also possible to make use of cloning kits in such rooms 120.

Extracting Laboratory

As it can be seen in FIG. 10, the plant cultivation facility 100 further comprises an extracting laboratory 122, wherein controlled substances such as cannabis can be extracted according to policies so as to uphold quality and consistency of all end products. Other than extraction laboratories, CO₂ laboratories can also be envisaged according to the present invention; the whole in accordance with governmental requirements and/or industry standards.

Shipping and/or Distribution Room

According the present invention, the plant cultivation facility 100 also contains a shipping and/or distribution room 124, which allows for the shipping and transportation of controlled substances. As known to a person skilled in the art, all shipping and distribution of cannabis for medical purposes shall be done in accordance with applicable law.

DC Chamber

As it can be seen in FIGS. 9 and 10, the plant cultivation facility 100 further comprises a DC chamber 126 (also known as a decontamination chamber). As it well known to a person skilled in the art decontamination chambers are designed for use in any pharmaceutical, manufacturing, laboratory, or research setting. They provide a gas-tight chamber for quick and easy decontamination of equipment and items entering a clean facility or for routine decontamination within a facility.

Other Multi-Purpose Rooms

The facility according to the present invention can also be fitted with other rooms, including production rooms to be able to produce different forms of cannabis, including but not limited to fresh and/or dried cannabis, oils, butter, teas, wax, shatter, tincture's, creams, topical creams, edibles, bubble hash, dry ice hash, rubs and/or ointments, vapor rubs, crude oil, rosin, live resin, dry THC and CBD crystallites, keif powder, oral mouth sprays, distillation oil's, oils for vape pen's and other dosage forms as permitted for by the law. Other forms may include fresh and/or dry cannabis, oils thereof, concentrates thereof, and other edible forms, as contemplated by a person skilled in the art.

Security Measures

In addition and considering the nature of the controlled substances to be grown in the secure plant cultivation facility 100 according to the present invention as well as regulatory compliance under the applicable law, the Applicant has created strict rules and regulations that must be abided by all persons entering the facility. More particularly, the secure facility according to the present invention is designed in a manner that prevents unauthorized access to certain chambers as well as tracks the supply chain of cannabis, from the beginning (i.e., seedlings, cultivation) to the end of the process (i.e., processing and selling and/or distribution thereof) in strict compliance with the law.

In a preferred embodiment, both the internal and external portions of the facility according to the present invention can be visually monitored at all times by visual recording devices (i.e., cameras, wireless cameras, etc.) to detect any attempted or actual unauthorized access to cannabis production and/or supply chain. The recording devices must, in the conditions under which they are used, be capable of making a visible recording of any attempted or actual unauthorized access to the facility, as well as to the individual chambers and/or rooms contained therein. The perimeter of the facility as well as the individual chambers and/or rooms contained therein can further be secured by means of an intrusion detection system that operates at all times and that allows for the detection of any attempted or actual unauthorized access to or movement in the site or tampering with the system. In a preferred embodiment, the intrusion detection system should be monitored at all times by personnel who must determine the appropriate steps to be taken in response to the detection of any occurrence referred to hereinabove. If any such occurrence is detected, the personnel should be able to make a record of: (a) the date and time of the occurrence; and (b) the measures taken in response to it and the date and time when they were taken.

If controlled substances, such as cannabis, are present within the facility (or site), access to those areas is restricted to persons whose presence in those areas is required by their work responsibilities. The responsible person in charge or, if applicable, the alternate responsible person in charge must be physically present while other persons are in those areas. Of course, a record must be made of the identity of every person entering or exiting those areas. Also provided in such areas where cannabis is present are physical barriers that prevent unauthorized access. In addition, all areas of the facility, including those where cannabis is present, are visually monitored at all times by visual recording devices to detect illicit conduct. These devices must, in the conditions under which they are used, be capable of making a visible recording of illicit conduct. Again, those areas of the facility where cannabis is present is further secured by means of an intrusion detection system that operates at all times and that allows for the detection of any attempted or actual unauthorized access to or movement in those areas or tampering with the system.

Areas wherein cannabis is present is further equipped with a system that filters air to prevent the escape of odors and, if present, pollen. These areas must also provided with an intrusion detection system, which must be monitored at all times by personnel who must determine the appropriate steps to be taken in response to the detection of any wrongful occurrence. If any such occurrence is detected, the personnel must make a record of: (a) the date and time of the occurrence; and (b) the measures taken in response to it and the date and time when they were taken.

Other security measures contemplated by the present invention are security clearances of personnel, including those of other licensed personnel (i.e., cultivators, processors, selling and/or distribution of cannabis products and its derivatives). In other words, security clearance should be applied for and/or obtained. With respect to clients, the Applicant shall maintain a registry of its clients and applications, which shall contain the original of the applicant's medical document or a copy of their registration certificate issued by the appropriate governmental authority, as well as the client's contact information, amongst other requirements (i.e., shipping address) as provided for by the law. The Applicant shall further maintain an address for the facility (or site) for the production of marihuana plans, as well as an address for the storage of cannabis. It shall also maintain other such documents and statements required by the law and conduct such verifications as required. To further enhance security measures, the applicant shall keep records of, for example, cannabis received and orders therefor, as well as visual recordings of the facility.

In other words, the facility according to the present invention is designed in such a way so as to allow one or more licensees or more particularly those who have obtained the appropriate authorizations from the regulatory authorities to operate their licenses in the facility according to the present invention.

In furtherance to the above, the Applicant shall keep all recordings and records required by the law, as well as those records as it pertains to good production practices and packaging, labelling and shipping, the sale or provision of dried marihuana, cannabis oil or marihuana plants or seeds, research and development efforts, destroyed cannabis, inventory, amongst other considerations.

Further contemplated by the present application is the automation of such security measures so as reduce costs and ensure compliance with said security measures, as prescribed by applicable law.

In a preferred embodiment, the Applicant has also developed a scheduling system, in which appointments have to be scheduled before a person can enter the facility according to the present invention. This same scheduling system according to the present invention could be applied to growing schedules of cannabis, as performed by one or more persons authorized or licensed to cultivate, process, sell and/or distribute cannabis. In this connection, personnel authorized to enter the facility must wear particular clothing (i.e., laboratory type clothing) and enter a decontamination chamber (DC chamber), which may be provided with measuring devices (i.e., scales) so as to measure a person's weight before entering designated zones of the facility and weighed thereafter so as to avoid theft of cannabis or any related forms thereof.

Computer and/or IT Systems (i.e., Cannabis Tracking System)

In yet another preferred embodiment of the invention, the plant cultivation facility 100 is provided with one or more computer and/or IT system(s) for registering, recording, identifying and verifying clients and persons who have ordered the controlled substance so as to ensure delivery of a given controlled substance thereto. The facility according to the present invention is further provided with a cannabis tracking system, which allow those persons authorized thereto to monitor production levels, inventory amounts, and sales volumes, amongst other details, such as: amounts by lot/batch) on:

Cannabis sown, propagated and harvested;

Cannabis obtained, returned, ordered, delivered, sent, and sold;

Cannabis destroyed;

Cannabis used at each stage of production (such as when it is transformed from one product class or form into another, or when it is chemically synthesized);

Cannabis used in research and development; and

Loss and theft (if any).

The cannabis tracking system is further facilitated by the use of a unique address and/or identifiers of the chambers of the facility according to the present invention. Indeed, the use of a unique address or identifier enables the facility's personnel to monitor the foregoing data sets, including but not limited to cannabis production, packaging, storage and tracking of each batch or lot of controlled substance associated to a given client or person and/or strain of controlled substance.

The Climate Controlled Growth Cultivation Chamber

By way of example, and as it can be seen in FIG. 11, the growth cultivation chamber 102 according to the present invention, comprises of several components, including but not limited to: (i) a wireless camera 140, (ii) an exhaust inlet 142, (iii) power meter 144, (iv) door 146 to enter the environment, (v) iPad 148, (vi) drain 150, (vii) CO₂ burner 152, (viii) growing pots 154, (ix) water hose 156, (x) table 158, (xi) wall fan 160, (xii) exhaust outlet 162, (xiii) A/C unit 164, (xiv) lighting system 166, (xv) electrical panel 168, (xvi) exhaust system 170, (xvii) HVAC system 172 and (xviii) electrical meters 174.

Growth Chamber Lighting and/or Electrical System

In a preferred embodiment, the growth cultivation chamber 102 is provided with sufficient electricity from the electrical room 114 to power each of the aforementioned components of said chamber 102.

The growth cultivation chamber 102 according to the present invention is also provided with an electrical panel 168, electrical meter 174, power meter 144 (or an electrical box) to supply and verify electricity consumption of the growth cultivation chamber 102; for example on an individual basis so as to measure the chamber's 102 energetic efficiency. As noted above, the power meter may be linked to the facility's electrical room 114.

As it can be seen in FIG. 11, the growth cultivation chamber 102 according to the present invention is provided with a lighting system 166, which shall be comprised of at least one (1) 1000 HPS light. In a preferred embodiment, the growth cultivation chamber 102 shall contain between four (4) to twelve (12) 1000 HPS lights 166.

CO₂ Control and/or Enrichment Systems

In a preferred embodiment, the growth cultivation chamber 102 is provided with a CO₂ burner 152. This burner 152 helps maintain the CO₂ level between 1000 to 2000 ppm, preferable between 1000 to 1500 ppm in the chamber 102. It is worth mentioning that the propane burned in the CO₂ unit adds a little heat and humidity to the chamber 102, a small convenience for the growth of the controlled substance. Usually a pilot light ignites the CO₂ at timed intervals to bring the CO₂ level to 1500 ppm. CO₂ naturally occurs in the air at the rate of 350 to 400 ppm. As CO₂ is heavier than air and tends to stratify and sink, it is important to have a proper ventilation system to keep the heavier-than-air CO₂ well mixed with the chamber's 102 air. As it can be seen in FIG. 11, the growth cultivation system is provided with a series of ventilation systems and/or fans 142, 160, 162, 164, 170 and 172 to ensure the movement of air and proper temperature control.

In the same vein, the growth cultivation chamber 102 of the present invention can also be provided with a CO₂ enrichment systems which can allow for the dispersion of CO₂ over the grow area. Various ways of adding CO₂ to the grow area include but are not limited to CO₂ generators, compressed CO₂, fermentation, CO₂ bag, compost and dried ice. CO₂ can be added to the grow (or plant) are during the plant's vegetative or flowering stage, enabling to maximize plant growth and yields. CO₂ generators can burn propane, ethyl alcohol or natural gas to produce CO₂. The disadvantage with the use of such generators is that they can: (i) increase humidity in a sealed cultivation chamber, (ii) produce head, (iii) produce too much CO₂. Compressed CO₂ usually comes in bottles or tanks and is one of the better ways of controllably injecting CO₂ into the grow space. Other than the cost factor of this system, compressed CO₂ allows for fine control of the amount of CO₂ (as expressed in parts per million, ppm) in the cultivation chamber, with the use of a regulator or controller. Fermentation uses natural processes to produce CO₂; however, said processes may produce low levels of CO₂ and/or cause unpleasant odors during the fermentation process. CO₂ bags use fungus growing on organic matter to produce CO₂. A drawback of using such bags is that many of them have to be used in a specific grow area to achieve the required range of CO₂ levels, as expressed in parts per million. With respect to the use of compost and composting process, it produces small amounts of CO₂, gives off odors and can be unsanitary. Lastly, the use of dry ice is not recommended as it is difficult to regulate CO₂ levels and is expensive to purchase.

By volume, dry air contains approximately 78.08% nitrogen, 20.95% oxygen, 0.93% argon, 0.04% carbon dioxide (CO₂), and small amounts of other gases (Mackenzie, F. T. and J. A. Mackenzie (1995), Our changing planet, Prentice-Hall, Upper Saddle River, N.J., p 288-307). Air also contains a variable amount of water vapor, on average around 1% at sea level, and 0.4% over the entire atmosphere. According to the NOAA Earth System Research Laboratory, there is about 400 ppm of CO₂ in regular air (available at: https://www.esrl.noaa.gov/gmd/ccgg/trends/global.html), which may be insufficient for enhanced plant growth and yield considerations. As such, it is preferable to enrich the grow environment (i.e., the cultivation chamber) with CO₂, at levels ranging between 1000 to 2000 ppm and more particularly between 1200 to 1500 ppm (0.12-0.15%). CO₂ enrichment in a grow environment can allow for many other advantages, including a more efficient photosynthetic process and improved plant yield; the whole being further dependent on photosynthetic photon flux densities, temperature and CO₂ conditions.

In a preferred embodiment, the facility according to the present invention is provided with at least one (1) bulk CO₂ unit 250-liter reservoir (i.e., a MVE bulk CO₂ system), which is connected to the growth pod. In another preferred embodiment, the facility is provided with two (2) or more MVE 250-litre reservoirs are used.

Growth Chamber Ventilation System (and/or Air Filtration Systems)

As it can be seen in FIG. 11, the growth cultivation system is provided with a series of ventilation systems and/or fans 142, 160, 162, 164, 170 and 172 to ensure the movement of air and proper temperature control. Indeed, proper air ventilation allows: (i) the plants to breathe as required with the needed gas exchanges, (ii) to evacuate the heat produced by the lighting system (i.e., lamps 166), (iii) to achieve a better climate control and thus allow the possibility of growing stronger plants. Ventilation systems are usually composed of, at least, two or three complementary elements, including for example: (i) an air extractor (or exhaust 162, 170), (ii) an interior fan 160 that moves the air of the growing space and, in most cases, an (iii) an intractor fan 142. It is well known to a person skilled in the art that the extractor fan is the key element of any air ventilation system, as it allows for the renewal of air and regulates the climate of the growth chamber. In such circumstances, the required extraction power depends on both the growing space and the lighting system used. As a rule of thumb, the more light output, the more powerful the extractor fan must be; such, of course, further depending on the dimensions of the growth chamber. In other words, to properly calculate the required power of the extractor for a given space, one must take into account different factors, such as: (1) light output used, (2) volume of the growing space and (3) the outdoor temperature.

In smaller spaces, intractor fans may not be necessary if a good extraction system is used. However, intractor fans can be used in cases where the plant environment needs to be renewed with fresh air from another room; and/or in such cases were the air pressure caused by the extractor needs to be reduced. However, in all cases, the airflow capacity of the intractor must always be lower than the extractor capacity, especially when using carbon filters.

Interior fans are a complementary piece of equipment to the extractor fan. While it is not a very efficient mean to decrease temperature, it prevents air stratification. Also, the use of interior fans may be beneficial for overall plant health as it allows for: (i) stronger branches and stems, which become more resistant and capable of supporting the weight of the buds at the end of the flowering stage; (ii) better air renewal inside the growing space, enhancing gas exchange; as well as (iii) decreased relative humidity levels, with less diseases and pests. As for the air extractor, it is important to use the correct fan size in relation to the size of the plants to be cultivated. Direct ventilation on seedlings and young cuttings is not advisable, since it could de-hydrate the tender and fragile foliage. However, as plants grow, it may be necessary to install larger fans so as to improve air circulation with a given growth chamber, and perhaps with speed control systems.

In a preferred embodiment, each growth cultivation chamber 102 is provided with at least one (1), preferably six (6), wall fans, of 55 watts.

The growth chamber can also be provided with an exhaust fan. Preferably, the exhaust fan consists of at least one (1) stealth 8″ fan, 745 cfm.

As it can further be seen in FIG. 11, the growth cultivation chamber 102 is provided with an A/C unit 164 and HVAC system 172. As known to a person skilled in the art, these units are designed to provide thermal comfort and acceptable indoor air quality, and is based on the principles of thermodynamics, fluid mechanics, and heat transfer. Refrigeration is sometimes added to such systems, as in the case of A/C units 164. Such ventilation systems are used for the process of exchanging or replacing air in any space to provide high indoor air quality, which involves temperature control, oxygen replenishment, and removal of moisture, odors, smoke, heat, dust, airborne bacteria, carbon dioxide, and other gases. Ventilation removes unpleasant smells and excessive moisture, introduces outside air, keeps interior building air circulating, and prevents stagnation of the interior air.

In any event, the foregoing systems described hereinabove can act as sensor and allow one to monitor and control temperature, humidity and other climatic events, which may occur within the growth cultivation chamber 102 of the present invention, either in person or via the monitors, such as the wireless camera 140 and control panel 148.

The growth chamber according to the present invention is also provided with an air monitor, such as an IGS-061 monitor or controller. In a preferred embodiment, this monitor must be installed in a position where light can be sensed by a photocell. It must not be installed too closely to the intake and/or exhaust fans or a CO₂ generator. It must also be protected from water and other particles, such as dust. It is known that such IGS-061 systems will perform CO₂ enrichment during the day only (when light is sensed by the photocell). The enrichment starts when the CO₂ concentration falls below the set point minus the differential. CO₂ enrichment starts below 1050 ppm and stops beyond 1050 ppm. As a safety feature, the high temperature shut off function will inhibit operation while temperature is over the user setting. This interruption is maintained until temperature falls below the user high temp setting. To inhibit this feature, it is possible to set the limit to its highest value. The IGS-061 controller can also be set to vent (extract) CO₂. Though it may be easier to add CO₂ in a closed environment with this controller, care will have to be exercised with growth chambers that make use of intake and/or exhaust ventilation systems so as to maintain adequate temperature and relative humidity levels. Indeed, adding CO₂ while these fans are “ON” may result in wasted CO₂. Therefore, it may also be preferable to make use of an “OFF” switcher to prevent the foregoing controller from adding CO₂ while other equipment is in operation.

The growth chamber according to the present invention is also provided with temperature monitor, such as a Cruise temperature controller, which allows for the control of heat or cold generators (with manual and programmable automatic defrosting). It may also allow for temperature display and adjustment; all with the purpose of controlling the growth chamber's temperature.

Growth Chamber Irrigation System

The growth chamber according to the present invention may also provided with an irrigation system, such as water hoses 156. In this connection, the irrigation system may be linked to the facility's water room 112. Many different other types of irrigation systems known to a person skilled in the art may be contemplated, including but not limited to: (i) manual watering with a water hose 156, (ii) rotation irrigation, (iii) flood irrigation, (iv) tip irrigation, (v) automatic watering, (vi) drip irrigation, and (vii) sprinkler irrigation.

Growth Chamber Grow Benches and Trays

In a preferred embodiment, the growth chamber is provided with at least one bench and at least one tray, of varying dimensions (e.g., 4×8 ft.). It is also possible to add other benches and trays. In a preferred embodiment, the benches are trays can be configured in various ways so as allow the tables 158 to be angled (i.e., inclined or declined) or flat; on which, the plants are cultivated thereon. Of course, other setups can be contemplated by a person skilled in the art. For example, flood-and-drain setups, in which flood tables, reservoirs, and pumps are used to feed plants water and nutrient solution and require mediums that can retain moisture for long periods of time. Pumps on timers flood the tables for short cycles and then drain the solution back into the reservoir (although some growers choose to drain the solution to waste and do not recycle it). Ebb-and-flow systems, deep-water cultures and many other setups or techniques (i.e., aeroponics, etc.) known to a person skilled in the art can be used.

Security and Control Monitoring Systems

In a preferred embodiment, both the grow cultivation chamber 102 and facility 100 are provided with at least one monitoring system in the form of wireless cameras 140, motion sensors, wireless devices, control panels 148 (i.e., iPads®, tablets and the like) to keep track of the plant growth stages, including growth cycle, feeding schedule, irrigation and etc., throughout production, as well as other monitors for the reasons set out in this application. In addition, the foregoing monitoring system and sensors can be used to ensure the security of the facility and/or growth chamber according to the present invention, as well as grow environment. For example, wireless security cameras 140 can be placed in front of each growth chamber as well as inside of each growth chamber so as to ensure a secure environment.

Growth Chamber Dimensions and Materials

The growth chamber of the present invention is preferably 10 feet wide and 20 feet long; but can, of course, be varied. In a preferred embodiment, the growth chamber can be made of galvanized steel. However, other dimensions and construction materials can be considered by a person skilled in the art.

Preferably, the growth chamber is constructed in such a manner that it can be hermetically sealed.

Growth Chamber Surface Coating

The growth chamber can be coated with, for example, protective coating that discourage the growth of mold, bacteria, mildew and/or other undesired products on the paint film and can with withstand corrosion as well as 3000 to 5000 ppm of carbon dioxide (CO₂). Preferably and as known to a person skilled in the art, the growth chamber will be primed with a special primer and powder coated.

Unique Address and/or Identifiers

As described in further detail hereinbelow, each chamber contained within the facility according to the present invention can be attributed its own unit number, i.e., an independent civic number; such by making use of a unit designator. The use of a unique address or identifier enables the personnel to be able to track the production, packaging, storage and tracking of each batch or lot of controlled substance associated to a given client or person and/or strain of controlled substance, as further indicated hereinabove.

At Least One Drying Chambers

As it can be seen in FIG. 12, the at least one drying chamber 104 further comprises of further components, including but not limited to: (i) a wireless camera 140, (ii) iPad 148, (iii) a dehumidifier 200, (iv) drying net 202, (v) drain 204, (vi) thermometer 206, (vii) drying fan 208, (viii) A/C unit 164, (ix) drying fan 210, (x) electrical panel 168, (xi) exhaust 170, (xii) and HVAC unit 172. It is worth mentioning that most of these components have already been described in the previous section.

In this connection, once the plant has been cut and is ready for drying, the facility's authorized personnel will be collect all of the plants from the growth chamber and transfer them to the drying chamber 104, which has been assigned with a corresponding unique address or identifier to the growth cultivating chamber 102. This facilitates the production, packaging, storage and tracking of each batch or lot of controlled substance associated to a given client or person and/or strain of controlled substance.

At this stage, the plants are trimmed and the leaves are separated from the flower. In a preferred embodiment and as it can be seen in FIG. 12, the flower portion of the plant is spread out onto one or more drying nets 202 and is dried with fans 208, 210 for approximately two to three days. In a preferred embodiment the drying room (or chamber) is totally blacked out. In order to extract the humidity of the room, at least one dehumidifier 200 can be used and any existent water in the drying chamber 104 can be drained through the drain 204. When the drying cycle has been completed, the flower is transferred into another recipient (i.e. Ziploc bags, glass jars or other types of containers). Once the flower (or bud) has been enclosed into the recipient it is “sweated out” so as to remove moisture from the flowers under controlled environmental conditions. This process can be repeated one or more times, and further repeated until the flower is cured; thereby providing much better product for multiple reasons. Once the flower (or bud) has been dried, it can be cured. Indeed, proper cannabis curing increases potency.

It is worth mentioning that the temperature of the drying chamber 104 can also be observed by making use of a thermometer 206, as well as any other control panel 148, which can be an iPad®. Of course, all other parameters (humidity, temperature, etc.), such as for the growth cultivation chamber 102 are monitored and controlled.

Other Advantages

In another preferred embodiment, the growth chambers may be stacked on top of one another, if necessary.
In a preferred embodiment, the growth chamber comprises of a hermetically sealed environment.

The benefit of such a growth chamber is that it releases minimal dampness in the facility environment.

In addition, by making use of the facility and growth chambers according to the present invention, plants may grow in a more efficient manner. In the initial phase, patients can choose a type of seed or strain of medical marihuana, which include Cannabis sativa, Cannabis indica or hybrid strains. The benefit of using known or different strains of cannabis is that each their own unique properties, chemical configuration and medical benefits. However, the life-cycle of one strain may be very different from another strain; therefore affecting the grow cycle from 60 days to, for example 90 days.

Patient Approval Process

comply with current legislation, the Applicant has developed a method to comply to such rules by making use of the facility and growth chambers according to the present invention.

In other words, the method to comply to the ACMPR comprises of the following steps:

1. Registration of the Registered Person;

2. Verifying the Registered Persons ACMPR license and/or prescription;

3. Approving the Registered Person as a client of the licensed producer;

4. Registered Person selects requirements for medical cannabis they wish to have grown on their behalf by a designated grower;

5. Registered Person and licensed producer shall jointly assign a designated grower and production address within the facility pursuant to an agreement;

6. Registered Person shall identify delivery schedule of the product. If there is an excess of product, it shall be stored in a security box or vault, in a designated location, of the facility;

7. Registered Person shall identify the delivery site and the form in which the product shall be in (i.e., dried cannabis, oil, etc.); the whole in conformity with applicable legislation.

Registered persons entering the facility must adhere to its strict regulations.

End Product

As a result of the design of the facility and growth chambers:

The designated growers and clients can have a specific strain of cannabis to be grown, in which the THC and/or CBD content can be varied;

A more efficient extraction process can be used to extract:

Dried flow ranges from 6% to 25% THC;

Dried flow ranges from 2% to 20% CDD;

Extracts and concentrates from 25% to 70% THC and/or CBD, as required;

Live Resin Extract from to 75% to 99% TCH and/or CBD.

The end-product will be of quality and can be transformed into a variety of forms, such as butter, teas, wax, shatter, tincture's, creams, topical creams, edibles, bubble hash, dry ice hash, rubs and/or ointments, vapor rubs, crude oil, rosin, live resin, dry THC and CBD crystallites, keif powder, oral mouth sprays, distillation oil's, oils for vape pen's and other dosage forms as permitted for by the law.

Thus, the design and functionality of the cultivation room and facility according to the present invention therefore becomes of importance in order to avoid the foregoing drawbacks associated to indoor cultivation and that allows for, for example: (i) the maintenance and balance between temperature, concentrations of CO₂ and other environmental and biological considerations (i.e., photosynthetic process) so as ensure better survival, growth and productivity of plants, such as cannabis, in drier and CO₂ rich environments, (ii) compliance with Good Production Practices (GPPs) as set forth in applicable legislation, (iii) prevents excess plant production from entering the underground economy; (iv) enhanced security measures; and (v) allows the resulting product to:

1. be within generally acceptable tolerance limits for herbal medicines for human consumption, as established in any publication referred to in the applicable legislation;

2. meet the requirements of a disintegration test that is applicable to the formulation of the capsule or similar dosage form and that is set out in any publication referred to in applicable legislation;

3. must not be treated with a pest control product unless the product is registered for use on marihuana under the Pest Control Products Act, S.C. 2002, c. 28 or is otherwise authorized for use under that Act (or any analogous legislation);

4. Cannabis oil must not exceed a pre-established maximum yield quantity of, for example, 30 mg of THC per milliliter of the oil in the immediate container;

5. If cannabis oil is in a capsule or similar dosage form, each capsule or unit of the dosage form must not exceed a pre-established maximum yield quantity of, for example, 10 mg of THC;

6. Cannabis oil must not contain residues of particular solvents according to applicable legislation. The residues must not exceed the limits established under the applicable policies;

7. Cannabis must be produced, packaged, labelled and stored in premises that are designed, constructed and maintained in a manner that permits those activities to be conducted under sanitary conditions, and in particular that: (a) permits the premises to be kept clean and orderly; (b) permits the effective cleaning of all surfaces in the premises; (c) permits the substance to be stored or processed appropriately; (d) prevents the contamination of the substance; and (e) prevents the addition of an extraneous substance to the substance;

8. must be produced, packaged, labeled and stored using equipment that is designed, constructed, maintained, operated and arranged in a manner that: (a) permits the effective cleaning of its surfaces; (b) permits it to function in accordance with its intended use; (c) prevents the contamination of the substance; and (d) prevents the addition of an extraneous substance to the substance;

9. must be produced, packaged, labeled and stored in accordance with a sanitation program that sets out: (a) procedures for effectively cleaning the premises in which those activities are conducted; (b) procedures for effectively cleaning the equipment used in those activities; (c) procedures for handling any substance used in those activities; and (d) all requirements, in respect of the health, hygienic behaviour and clothing of the personnel who are involved in those activities, that are necessary to ensure that those activities are conducted in sanitary conditions;

10. must be produced, packaged, labelled and stored in accordance with standard operating procedures that are designed to ensure that those activities are conducted in accordance with the requirements of the law;

11. meets all other required quality assurance standards as set forth in the law, as well as packaging, labeling and shipping standards.

The novel features will become apparent by those of skill in the art upon examination of the description. It should be understood, however, that the scope of the claims should not be limited by the embodiments, but should be given the broadest interpretation consistent with the wording of the claims and the specification as a whole.

1. A secure plant cultivation facility in which each growth cultivation chamber and drying chamber contained therein are assigned with a unique address or identifier so as to facilitate the production, packaging, storage and tracking of each batch or lot of controlled substance associated to a given client or person and/or strain of controlled substance.

2. The secure plant cultivation facility according to claim 1, wherein the facility comprises:
at least one climate controlled growth cultivation chamber with a unique address or identifier for growing a controlled substance;
at least one drying chamber with a corresponding unique address or identifier with the at least one climate controlled growth chamber; said drying chamber used for subjecting the controlled substance to a drying process;
at least one laboratory for testing said controlled substances and ensuring quality thereof;
a storage chamber, which allows for the storage of controlled substances for clients or persons who require the controlled substance up to the shipment thereof; said storage chamber further comprising a vault;
security measures which allow for the detection and monitoring of the facility as well as the safeguarding the controlled substances contained therein from unauthorized access;
a computer and/or information technology system for registering, recording, identifying and verifying clients and persons who have ordered the controlled substance so as to ensure delivery of a given controlled substance thereto; and
other multi-purpose rooms.

3. The secure plant cultivation facility of claim 1, further comprising automation software allowing for the operating, monitoring, scheduling and controlling of components of the facility as well as environmental and agricultural conditions therein, as well as provide for asset and inventory management of controlled substances so processed within the facility.

4. The secure plant cultivation facility of claim 3, wherein the automation software may push real-time notifications to users, thereby enabling said users to rectify crop, environmental and agricultural deficiencies within the facility or with respect to the controlled substances cultivated therein.

5. The secure plant cultivation facility of claim 1, further comprising at least one multi-directional automation device having a processor in communication with automation software, means for moving, and at least one or more implements for any one of planting, seeding, crop monitoring, weeding, spraying, irrigating, moving, thinning, pruning, grading, picking and harvesting controlled substances, imaging as well as sensing crop, environmental and agricultural conditions.

6. The secure plant cultivation facility of claim 1, further comprising sensors and sensor network in communication with automation software for measuring crop, environmental and agricultural conditions; wherein the sensor is one of a crop or controlled substance sensor, a soil sensor, a climatic or environmental sensor, a bio-sensor, a pressure sensor, temperature sensor, as well as an imaging sensor or device.

7. The secure plant cultivation facility of claim 5, further comprising sensors and sensor network in communication with automation software for measuring crop, environmental and agricultural conditions; wherein the sensor is one of a crop or controlled substance sensor, a soil sensor, a climatic or environmental sensor, a bio-sensor, a pressure sensor, temperature sensor, as well as an imaging sensor or device.

8. Method of operating a secure plant cultivation facility and automation system, comprising the steps of:
moving at least one moveable automation device within chambers of the facility; and
operating an implement of the at least one moveable automation device so as to perform various agricultural operations on each batch or lot of controlled substance.

9. Method of operating a secure plant cultivation facility according to claim 8, including a step of transmitting data from either the automation device or each chamber of the facility to a processor or to be processed by the automation software.
